(19) United States
(12) Patent Application Publication
(10) Pub. No.: US 2019/0058174 A1
(43) Pub. Date: Feb. 21, 2019

(54) BATTERY PACK AND METHOD FOR PRODUCING A BATTERY PACK

(71) Applicant: Unicorn Energy GmbH, Schwaebisch Gmuend (DE)

(72) Inventors: Ruediger Nierescher, Schwaebisch Gmuend (DE); Michael Preiss, Schwaebisch Gmuend (DE)

(73) Assignee: Unicorn Energy GmbH, Schwaebisch Gmuend (DE)

(21) Appl. No.: 16/081,185

(22) PCT Filed: Dec. 28, 2016
(86) PCT No.: PCT/EP2016/082792

§ 371 Date: Aug. 30, 2018

(30) Foreign Application Priority Data
Mar. 1, 2016 (DE) 10 2016 103 667.6

(51) Int. Cl. H01M 2/10; H01M 2/02; H01M 10/42; H01M 10/613; H01M 2/20

(52) U.S. Cl. CPC H01M 2/1077; H01M 2/022; H01M 2/202; H01M 10/613; H01M 10/425

(57) ABSTRACT

A battery pack having at least one battery cell, wherein the battery cell is coupled and electrically conductively connected to connecting elements at its battery poles, is configured and developed in respect of simplified production with simple structural means in such a way that the battery cell is positioned on a flat conductor element and that the battery cell is electrically conductively connected to the conductor element by a separating process and/or a shaping process between connecting elements and conductor element and is fixed to or on the conductor element.

### BACKGROUND OF THE INVENTION

The present invention relates to a battery pack having at least one battery cell, wherein the battery cell is coupled and electrically conductively connected to connecting elements at its battery poles. The present invention also relates to a method for producing a battery pack having at least one battery cell, wherein the battery cell is coupled and electrically conductively connected to connecting elements at its battery poles.

Battery packs and methods for producing battery packs of this kind are known from the prior art. Battery packs are available in various different designs and sizes and with different numbers of cells, and are used to supply power to energy consumers connected to battery packs independently of the mains. A battery pack is known from DE 10 2012 007 958 U1, for example.

Battery packs are problematic in that they are largely produced manually due to the large number of components to be assembled and the complexity of the assembly steps. This results in high costs for producing battery packs. In addition, consistent quality can only be maintained by strict quality control due to assembly being carried out manually. This is associated with high costs as well.

### SUMMARY OF THE INVENTION

The problem addressed by the present invention is making it possible to produce battery packs in a simple and reliable manner using simple structural means.

The invention solves the above problem by means of a battery pack having the features of claim 1. According to said claim, the battery pack is characterized in that the battery cell is positioned on a flat conductor element and in that the battery cell is electrically conductively connected to the conductor element by a separating process and/or a shaping process between connecting elements and the conductor element and is fixed to or on the conductor element.

The battery pack according to the invention provides a structurally simple and simultaneously stable option for connecting a battery cell and a flat conductor element. A connecting element that interacts with the flat conductor element is used for this purpose. The connecting element is positioned or placed on the conductor element and is pressed against the conductor element. Here, a separating process and/or a shaping process takes place between the connecting element and the conductor element. As a result, the connecting element is mechanically connected to the conductor element. An electrically conductive connection is established between the conductor element and the connecting element. Advantageously, it is possible to couple a battery cell to a flat conductor element without a bonded connection, such as soldering. Machine manufacturing then can become the preferred option. The battery cell can be electrically contacted or a plurality of battery cells can be brought into contact with one another by means of the flat conductor element.

The term “battery cell” is to be understood in the broadest sense. A battery cell may thus be a cell-like energy storage device in the form of an electrochemical storage device or another electrical storage device.

In relation to the coupling between the connecting element and the battery cell, it is conceivable for the connecting element to be directly or indirectly connected to the battery cell.

Specifically, the connecting elements may each comprise contact portions by means of which the connecting elements can be pressed, punched, crimped or clamped into the conductor element. By carrying out such a process, the contact portions of the connecting elements have been pressed, punched, crimped or clamped into the flat conductor element. In this way, mechanical fastening and electrical or electronic contacting can be produced in one single step. The contact portions may for example be embodied as pins, cutting edges, blades or connectors. An embodiment comprising an insulation-displacement connector as a contact portion, which acts as a barb, is also conceivable.

Recesses or passages may be made in the conductor element for receiving the contact portions. Owing to a connection process of this type, which substantially proceeds from a translational movement (straight-line movement), automated machine manufacturing of battery packs then can be the preferred option.

Advantageously, the connecting elements may each be connected, in particular welded, to the battery cell by means of a contact plate. This results in a simple and robust connection. Specifically, the contact plate may be welded to the battery cell and to the connecting element.

In order to reduce the number of assembly steps, the connecting element (optionally along with contact elements) and the contact plate may be integrally formed. As a result, only one element, which has a stable construction, needs to be handled. Fastening to a battery pole of the battery cell can be carried out by soldering.

In order to allow as much pre-assembly as possible, the connecting element (optionally along with contact elements) and the contact plate may be integrally formed with a battery pole of a battery cell. As a result, the stability is increased and the assembly is simplified further. The connecting element and the contact plate are then already integrally formed with a battery pole of the battery cell when the battery cell is produced.

The battery cell can be fixed by a cell holder. Therefore, one or more battery cells can be arranged in a cell holder in a shock-proof and protected manner. The battery cell can be inserted or glued into the cell holder.

The unit made up of the cell holder, battery cell, connecting element and contact plate constitutes a cell pack and can be handled as such.

The contact plate and the connecting element together form a cell-contacting element.

Expediently, the cell holder may comprise a lower part and an upper part, which can be fastened to one another by means of a clamped connection. Once this connection is established, for example by pressing the upper part and the lower part together, the upper part and the lower part are fastened to one another. Separate joining means can be omitted. By the clamped connection being able to be established by the upper part and the lower part being translationally brought together, machine production is once again the preferred option. The clamped connection may be a snap-in hook connection, for example. In this way, a stable connection between the upper part and the lower part can be established.

Advantageously, one of the parts from among either the upper part or the lower part may comprise guide pins and the other part from among either the upper part or the lower part may comprise recesses or passages for receiving the guide pins. This simplifies the process, since there is guidance between the upper part and the lower part, specifically irrespective of any clamped connection or snap-in hook connection. This again makes machine manufacturing of a battery pack the preferred option.

Expediently, the cell holder may comprise a receiving region in which a contact plate is held. The receiving region may be designed as a receiving slot for a contact plate. It is conceivable for said receiving region to be arranged on the lower part of the cell holder.

The cell holder may comprise receiving portions in or on each of which one of the connecting elements is received and/or fixed. In this way, the contact plate and the connecting elements can be inserted into the cell holder separately from one another, are held in position thereby, and can be connected in the cell holder, for example can be welded to one another. The receiving portions may be designed as extensions of the cell holder, in particular of the lower part of the cell holder, and may comprise passages, into which the connecting elements can be inserted.

Expediently, protruding positioning pins may be formed on the cell holder, in particular on the lower part of the cell holder, and recesses may be formed on the conductor element that correspond to the positioning pins. This ensures that the battery cell and/or the cell holder are associated with the conductor element. As a result, placing the cell holder onto the conductor element in an automated manner in a precise position is the preferred option.

Advantageously, the cell holder may comprise compensating elements for tolerance compensation for the thickness of the battery cells. It is therefore ensured that one or more battery cells are received and fixed in place even if the thickness of the battery cells differs.

It is conceivable here for the compensation elements to be in the form of silicone-filled pockets. The length of the battery cells can be compensated for by the contact plates being designed to be flexible.

The flat conductor element may for example be a support element for electronic components, or may be a board or a printed circuit board. In particular, the flat conductor element may be designed as a printed circuit board equipped with electronic components. The flat conductor element may be planar or curved, for example in the form of a segment of a cylinder surface.

Expediently, at least one battery cell may be positioned on each of the two opposite sides of the flat conductor element, in particular in the form of cell packs held by the cell holder. In addition to the battery pack having compact dimensions, a thermally advantageous arrangement is also achieved.

Advantageously, battery cells may be arranged on top of one another in a plurality of layers, in particular at least two layers, on at least one side of the flat conductor element. As a result, a higher number of cells and thus higher capacities can be achieved using just one board. In this case, battery cells may be interconnected by contact plates at battery poles.

When viewed in cross section, the battery cells may be arranged centrally on top of one another (face-centered), i.e. a battery cell may rest on a second battery cell so as to be centrally oriented. The clearances between the battery cells may be used for cooling. Equally, a battery cell in a second layer may be arranged in the gap on two battery cells in a first layer (body-centered). As a result, a comparatively dense and compact arrangement of battery cells can be achieved.

A plurality of battery cells arranged in one layer does not necessarily have to be arranged in one plane. Therefore, a layer can also be formed by a plurality of slightly mutually offset battery cells. The layer may thus have a curved shape.

Irrespective of the arrangement of the battery cells, said cells may be connected in series in order to achieve the desired voltage. The battery cells may be conductively interconnected by contact plates at their battery poles. Battery cells can then contact the flat conductor element at either end of the series connection.

Expediently, a housing that receives the battery pack is provided that has a round or n-polygonal cross section where n>3 (n defining the number of edges). As a result, a suitable outer housing is provided for the battery pack. A housing having an n-polygonal cross section may be designed as a triangular, quadrilateral, square or hexagonal housing. The hexagonal housing is in a honeycomb shape and therefore can be stacked easily.

The problem stated at the outset is also solved by a method having the features of the coordinate claim. According to said claim, the method is characterized in that the battery cell is being positioned on a flat conductor element and in that the connecting elements coupled to the battery cell interact with the conductor element such that the battery cell is being electrically conductively connected to the conductor element by a separating process and/or a shaping process between connecting elements and the conductor element and is being fixed to or on the conductor element.

With regard to the advantages that can be achieved and to inventive step, reference is made to the comments in connection with claim 1.

Expediently, the connecting elements each comprise contact portions by means of which the connecting elements are being pressed, punched, crimped and/or clamped into the conductor element when the battery cell is positioned or placed onto the conductor element. The contact portions may be formed as pins, cutting edges, blades or connectors. Insulation-displacement connectors in the form of a barb are also conceivable. Passages or recesses may be made in the conductor element for receiving the contact portions, and these constitute the connecting-element receiving portions. In this way, in one step, mechanical fastening and electrical or electronic contacting can be produced. Automatic manufacturing is the preferred option.

Advantageously, the connecting elements may be coupled, in particular welded, to the battery cell by means of a contact plate. A simple and robust connection is produced. Specifically, the contact plate may be welded to the battery cell and to the connecting element.

Alternatively, it is conceivable for the connecting element (optionally along with contact portions) to be integrally formed with the contact plate. This saves an assembly step and increases the stability. In addition, the connecting element (optionally along with contact portions) and the contact plate may be integrally formed with a battery pole of a battery cell. This may take place as early as when the battery cell is produced. The level of pre-assembly is thus increased, meaning that the actual assembly of the battery pack is further simplified.

The battery cell can be fixed by a cell holder. Therefore, one or more battery cells can be arranged in a cell holder in a shock-proof and protected manner. The battery cell can be inserted or glued into the cell holder.

Expediently, the cell holder may comprise a receiving region into which the contact plate is being inserted. The receiving region may be designed as a receiving slot for a contact plate. It is conceivable for said receiving region to be arranged on the lower part of the cell holder.

The cell holder may comprise receiving portions in or on each of which one of the connecting elements is being inserted. It is advantageous here for said elements to be inserted before the battery cell and/or the cell holder is positioned on the conductor element. In this way, the contact plate and the connecting elements can be inserted into the cell holder separately from one another and for example can be welded to one another. The receiving portions may be designed as extensions of the cell holder, in particular of the lower part of the cell holder, and may comprise passages, into which the connecting elements are being inserted.

Advantageously, protruding positioning pins may be formed on the cell holder, in particular on the lower part of the cell holder, which are being guided to position the battery cell and/or the cell holder on the conductor element in recesses formed in the conductor element. This ensures that the battery cell and/or the cell holder are associated with the conductor element. Automated assembly is the preferred option.

Expediently, battery cells can be positioned on two opposite sides of the flat conductor element, in particular in the form of cell packs held by the cell holder. In addition to the battery pack having compact dimensions, a thermally advantageous arrangement is also achieved in this way.

To further develop the method for producing a battery pack, the measures described in connection with the battery pack can also be read such that they are applicable to the method.

### BRIEF DESCRIPTION OF THE DRAWINGS

The invention is explained in greater detail in the following with reference to the drawings, wherein like or functionally like elements may only be provided with reference signs once. In the drawings:

FIG. 1 is an exploded view of an embodiment of a battery pack and a view of an embodiment of said battery pack when assembled;

FIG. 2 shows a plurality of schematic views of a cell pack of the battery pack from FIG. 1;

FIG. 3 schematically shows a front view, a side view and a sectional view of an embodiment of a battery pack comprising three battery cells and a triangular housing;

FIG. 4 schematically shows a perspective view, a side view and a sectional view of an embodiment of a battery pack comprising six battery cells and a hexagonal housing; and

FIGS. 5a and 5b show schematic views of embodiments of battery packs comprising battery cells arranged in a plurality of layers.

### DETAILED DESCRIPTION

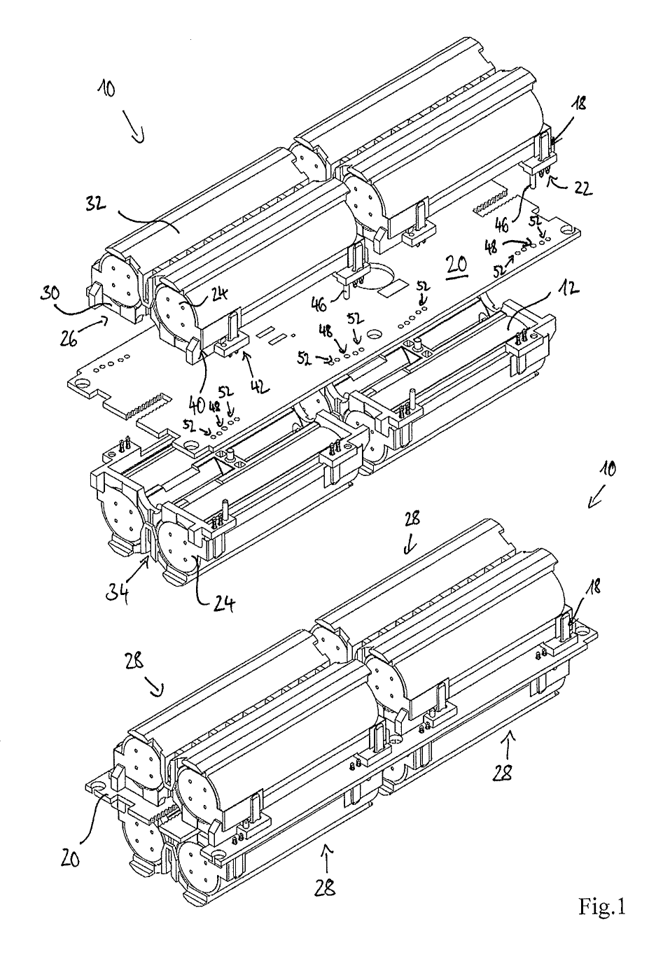

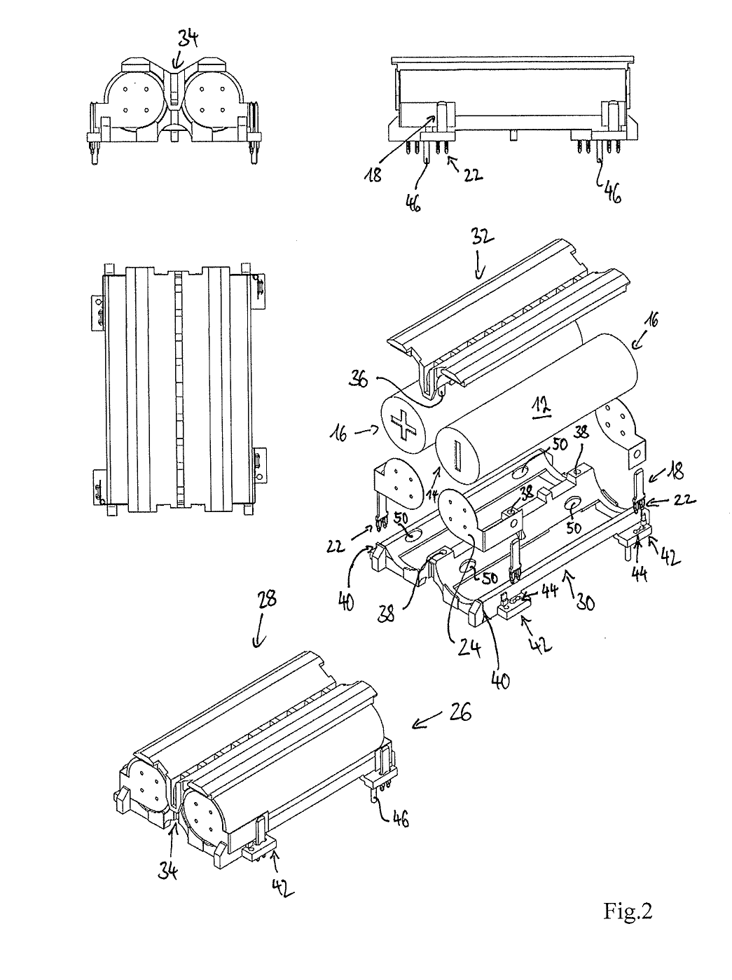

FIG. 1 shows an embodiment of a battery pack, which is denoted by reference sign 10 as a whole. The battery pack 10 comprises at least one battery cell 12. The battery cell 12 is coupled and electrically conductively connected to connecting elements 18 at its battery poles 14, 16 (see FIG. 2).

The battery cell 12 is positioned on a flat conductor element 20. The battery cell 12 is electrically conductively connected to the conductor element 20 by a separating process and/or a shaping process between connecting elements 18 and the conductor element 20 and is fixed to or on the conductor element 20 (see FIG. 1).

The connecting elements 18 each comprise contact portions 22 by means of which the connecting elements 18 can be pressed, punched, crimped or clamped into the conductor element 20. In the present embodiment, the contact portions 22 are designed as connectors that are clamped into the conductor element 20.

The connecting elements 18 are each connected, specifically welded, to the battery cell 12 by means of a contact plate 24. The battery cell 12 is fixed by a cell holder 26. The unit made up of the cell holder 26, at least one battery cell 12, contact plates 24 and connecting elements 18 forms a cell pack 28 (see FIG. 2). The cell pack 28 can be individually handled as such.

The cell holder 26 comprises a lower part 30 and an upper part 32. The lower part 30 and the upper part 32 can be fastened to one another by means of a snap-in hook connection 34.

One of the parts from among either the upper part 32 or the lower part 30 comprises a plurality of guide pins 36, preferably three, and the other part from among either the upper part 32 or the lower part 30 comprises recesses or passages 38 for receiving the guide pins 36.

The cell holder 26 comprises, on its lower part 30, at least one receiving region 40 in which a contact plate 24 is held. In the present case, the lower part 30 comprises four receiving regions 40 for four contact plates 24. The receiving region 40 is designed as a receiving slot.

The cell holder 26 also comprises, on its lower part 30, receiving portions 42 in or on each of which one of the connecting elements 18 is received and/or fixed. In the present case, four receiving portions 42 are formed on the lower part 30 for four connecting elements 18. The receiving portions 42 are designed as extensions having passages 44.

Two protruding positioning pins 46 are formed on the cell holder 26 and in particular on the lower part 30 of the cell holder 26, and two recesses 48 are formed on the conductor element 20 that correspond to the positioning pins 46.

The cell holder 26 comprises compensating elements 50 for tolerance compensation for the thickness of the battery cells 12. The compensating elements 50 are in the form of silicone-filled pockets (see FIG. 2).

In the present embodiment, the contact portions 22 of the connecting elements 18 are designed as connectors. Said connectors are inserted into connecting-element receiving portions 52, which are designed as connector passages in the present embodiment.

The flat conductor element 20 is designed as an equipped printed circuit board.

The method for producing a battery pack 10 comprising at least one battery cell 12 may proceed as follows:

First, the cell holder 26, with its lower part 30 and upper part 32, is being provided. The connecting elements 18 and the contact plates 24 are being inserted into the receiving region 40 and the passages 44 in the receiving portion 42. A connecting element 18 is being welded to the associated contact plate 24 in each case.

The battery cells 12 are then being inserted and/or glued into the lower part 30 of the cell holder 26, taking into account the installation direction.

The upper part 32 of the cell holder 26 is being placed onto the lower part 30 of the cell holder 26, the guide pins 36 being guided in the passages 38. The upper part 32 of the cell holder 26 is fixed to the lower part 30 of the cell holder 26 by the snap-in hook connection 34.

The contact plates 24 are then being welded to the battery poles 14, 16 of the battery cell 12. This thus completes a cell pack 28.

Subsequently, the flat conductor element 20 in the form of an equipped printed circuit board is provided and positioned. The battery cells 12 and the cell pack(s) 28 are positioned relative to the flat conductor element 20 by means of the positioning pins 46 that engage in recesses 48 corresponding thereto.

The battery cells 12 and the cell pack 28 are then being electrically connected to the flat conductor element 20 in the form of an equipped printed circuit board. In the present embodiment, the connecting elements 18 in the form of connectors are pressed into connecting-element receiving portions 52 formed as connector passages 52.

Therefore, the battery cells 12 and the cell pack 28 are being mechanically fixed to the flat conductor element 20 in the form of a printed circuit board and are electrically conductively connected to the printed circuit board.

All the cell packs 28, namely four cell packs 28 each having two battery cells 12 in the present embodiment, are being positioned on either side of the flat conductor element 20 and, in the manner described, are being electrically connected to the conductor element 20 and fixed to the conductor element 20. By means of the conductor element 20, the battery cells 12 of a cell pack 28 are brought into contact with one another and the battery cells 12 of a plurality of cell packs 28 are contacted. This thus completes a battery pack 10.

The battery pack 10 may also comprise a housing and electrical connections for contacting energy consumers and/or for bringing a plurality of battery packs into contact with one another (not shown).

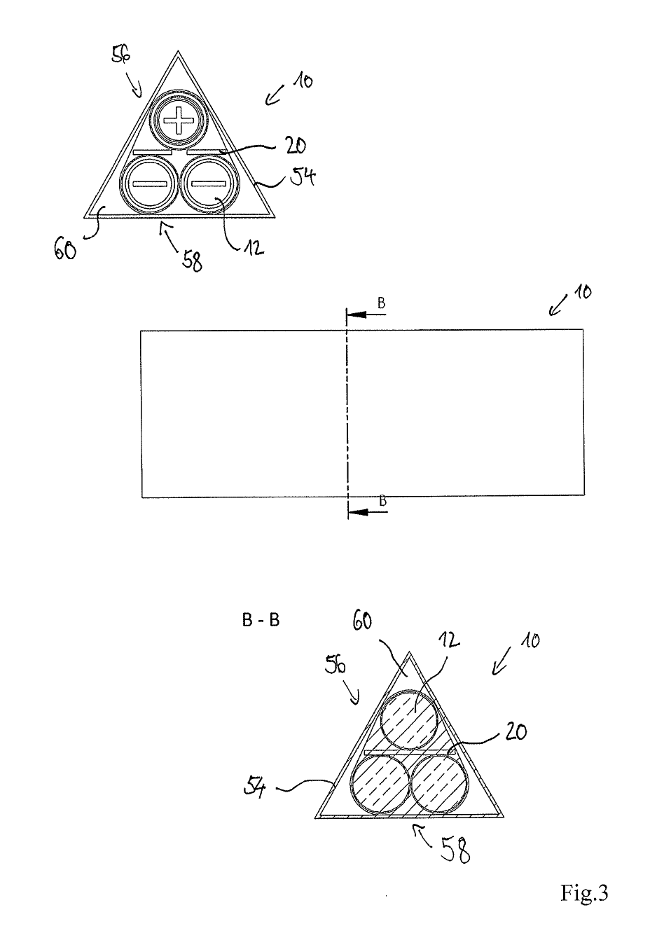

FIG. 3 shows a plurality of schematic views of a battery pack 10 comprising three battery cells 12. The battery pack 10 comprises a triangular housing 54. The battery cells 12 are each arranged in a layer on the flat conductor element 20. A battery cell 12 is arranged on a first face 56 of the flat conductor element 20. Two battery cells 12 are arranged on a second face 58 of the flat conductor element 20. The clearances 60 between the battery cells 12 and the housing 54 may be used for cooling or ventilating the battery pack 10.

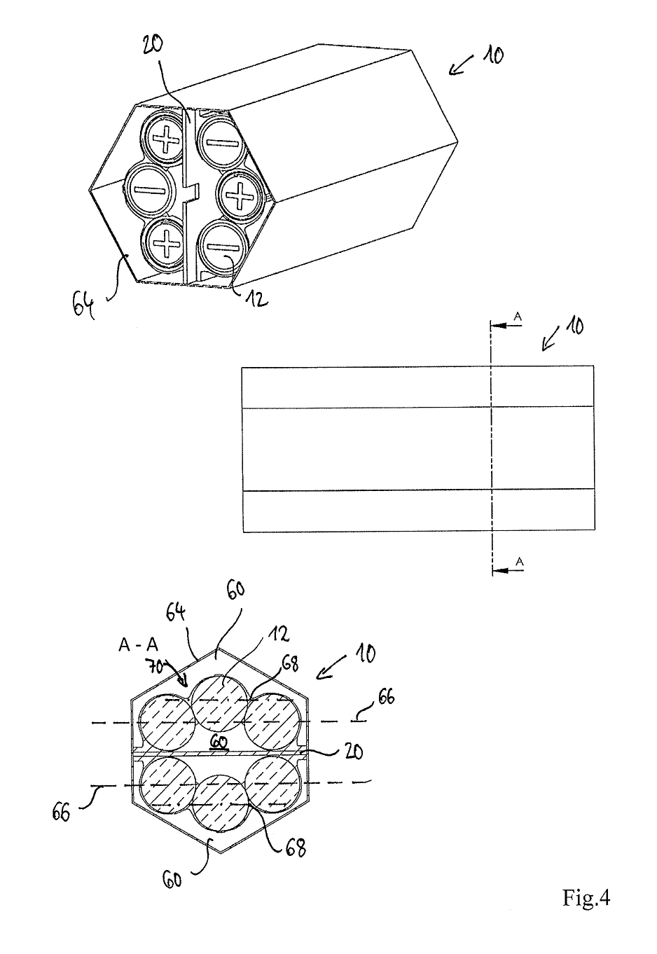

FIG. 4 shows a plurality of schematic views of a battery pack 10 comprising six battery cells 12. The battery pack 10 comprises a hexagonal housing 64. The battery cells 12 are arranged on the first face 56 and the second face 58 of the flat conductor element 20 in a first layer 66 and a second layer 68, respectively. In this case, the battery cell 12 arranged in the second layer 68 is positioned in a gap 70 between the battery cells 12 arranged in the first layer 66. The clearances 60 between the battery cells 12 and the housing 64 may be used for cooling or ventilating the battery pack 10.

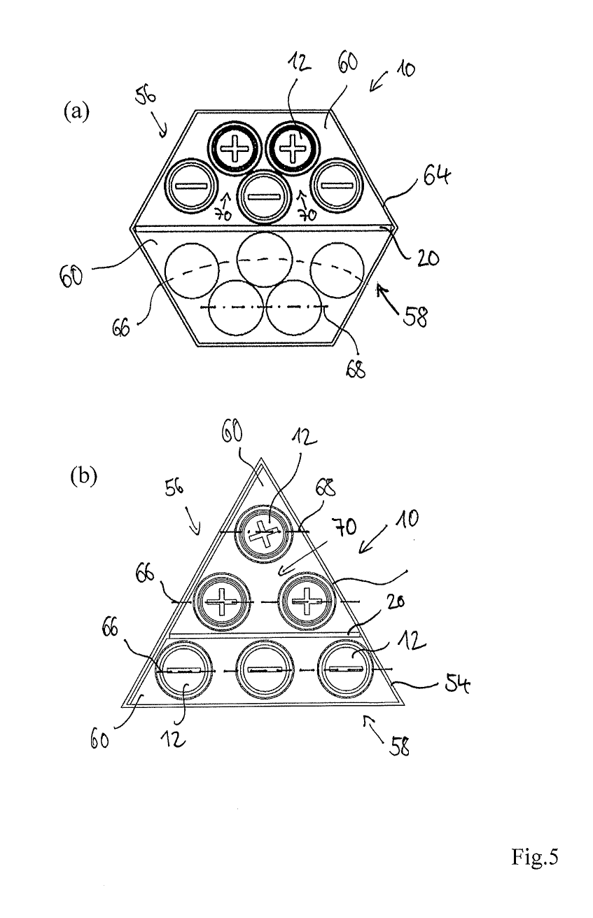

FIG. 5(a) is a front view of a battery pack 10 comprising ten battery cells 12. The battery pack 10 comprises a hexagonal housing 64. The battery cells 12 are arranged on the first face 56 and the second face 58 of the flat conductor element 20 in a first layer 66 and a second layer 68, respectively. The first layer 66 is curved and the second layer 68 is flat. The battery cells 12 arranged in the second layer 68 are positioned in gaps 70 between the battery cells 12 arranged in the first layer 66. The clearances 60 between the battery cells 12 and the housing 64 may be used for cooling or ventilating the battery pack 10.

FIG. 5(b) is a front view of a battery pack 10 comprising six battery cells 12. The battery pack 10 comprises a triangular housing 64. The battery cells 12 are arranged on the first face 56 of the flat conductor element 20 in a first layer 66 and a second layer 68. The battery cell 12 arranged in the second layer 68 is positioned in a gap 70 between the battery cells 12 arranged in the first layer 66 and is spaced apart therefrom. The battery cells 12 are arranged on the second face 58 of the flat conductor element 20 in a first layer 66. The clearances 60 between the battery cells 12 and the housing 64 may be used for cooling or ventilating the battery pack 10.

What is claimed is:

1. A battery pack having at least one battery cell, wherein the battery cell is coupled and electrically conductively connected to connecting elements at its battery poles, characterized in that the battery cell is positioned on a flat conductor element, that the connecting elements each comprise contact portions by means of which the connecting elements can be pressed, punched, crimped and/or clamped into the conductor element, such that the battery cell is electrically conductively connected to the conductor element and is fixed on the conductor element.

2. The battery pack according to claim 1, characterized in that the connecting elements are each connected to the battery cell by means of a contact plate, and/or in that the battery cell is fixed by a cell holder.

3. The battery pack according to claim 2, characterized in that the connecting element and the contact plate are integrally formed.

4. The battery pack according to claim 2, characterized in that the cell holder comprises a lower part and an upper part, which can be fastened to one another by means of a clamped connection.

5. The battery pack according to claim 4, characterized in that one of the parts from among either the upper part or the lower part comprises guide pins and the other part from among either the upper part or the lower part comprises recesses or passages for receiving the guide pins.

6. The battery pack according to claim 2, characterized in that the cell holder comprises a receiving region in which a contact plate is retained.

7. The battery pack according to claim 2, characterized in that protruding positioning pins are formed on the cell holder and in that recesses are formed on the conductor element that correspond to the positioning pins.

8. The battery pack according to claim 2, characterized in that the cell holder comprises compensating elements, in particular silicone-filled pockets, for tolerance compensation for the thickness of the battery cells.

9. The battery pack according to claim 1, characterized in that the flat conductor element is formed as an equipped printed circuit board and in that at least one battery cell is positioned on each of the two opposite sides of the flat conductor element.

10. The battery pack according to claim 1, characterized in that battery cells are arranged in a plurality of layers on at least one side of the flat conductor element.

11. A method for producing a battery pack having at least one battery cell, wherein the battery cell is being coupled and electrically conductively connected to connecting elements at its battery poles, characterized in that the battery cell is being positioned on a flat conductor element, and in that the connecting elements each comprise contact portions by means of which the connecting elements are being one of pressed, punched, crimped and clamped into the conductor element, such that the battery cell is being electrically conductively connected to the conductor element and is being fixed on the conductor element.

12. The method according to claim 11, characterized in that the connecting elements are being coupled to the battery cell by means of a contact plate, and/or in that the battery cell is being fixed by a cell holder.

13. The method according to claim 12, characterized in that the cell holder comprises a receiving region into which a contact plate is being inserted.

14. The method according to claim 12, characterized in that protruding positioning pins are formed on the cell holder that are being guided in recesses formed in the conductor element in order to position the battery cell on the conductor element.

15. The method according to claim 11, characterized in that battery cells are being positioned on two opposite sides of the flat conductor element.

16. The battery pack according to claim 3, wherein the connecting element and the contact plate are integrally formed with a battery pole of the battery cell.

17. The battery pack according to claim 2, wherein the cell holder comprises receiving portions to which one of the connecting elements can be received.

18. The battery pack according to claim 1, wherein a housing that receives the battery pack is provided that has a round or n-polygonal cross section where n>3.

19. The battery pack according to claim 9, wherein said at least one battery cell is positioned in the form of cell packs held by the cell holder.

20. The method according to claim 12, in that the cell holder comprises receiving portions to which one of the connecting elements is being inserted.
